(19) United States
(12) Patent Application Publication
(10) Pub. No.: US 2011/0175445 A1
(43) Pub. Date: Jul. 21, 2011

(54) FUEL CELL SYSTEM AND POWER MANAGEMENT METHOD THEREOF

(75) Inventors: Kuo-Tai Hung, Hsinchu County (TW); Ken-Chih Chang, Hsinchu County (TW)

(73) Assignee: YOUNG GREEN ENERGY CO., Hsinchu County (TW)

(21) Appl. No.: 12/978,635

(22) Filed: Dec. 27, 2010

(30) Foreign Application Priority Data
Jan. 15, 2010 (CN) 201010002981.5

(51) Int. Cl. H02J 1/00

(52) U.S. Cl. 307/24

(57) ABSTRACT

A fuel cell system including a fuel cell power-generating part, a state detector, a charging circuit, a secondary cell, a control unit, a first internal load power supply circuit, a second internal load power supply circuit, a path selection circuit, an internal load, and an external load power supply circuit is provided. The first internal load power supply circuit and the charging circuit are coupled to the fuel cell power-generating part. The secondary cell is coupled between the charging circuit and the second internal load power supply circuit. The path selection circuit determines whether the first internal load power supply circuit or the second internal load power supply circuit provides power to the internal load according to a first electric power of the fuel cell power-generating part that is detected by the state detector, so as to reduce energy consumption.

### CROSS-REFERENCE TO RELATED APPLICATION

This application claims the priority benefit of China application serial no. 201010002981.5, filed on Jan. 15, 2010. The entirety of the above-mentioned patent application is hereby incorporated by reference herein and made a part of this specification.

### BACKGROUND OF THE INVENTION

1. Field of the Invention

The invention relates to a power supply system. More particularly, the invention relates to a fuel cell system and a power management method thereof.

2. Description of Related Art

Development and application of energy have always been indispensable conditions of human life but the development and application of energy may cause damage to the environment gradually. Fuel cell technique for generation energy which has advantages of high efficiency, low noise, and pollution-free, etc. is a trend nowadays. However, a power-generating cost for a current fuel cell is rather high, so that a power control technique thereof needs to be further improved, and whole power supply efficiency may be improved through a suitable circuit structure and power control, so as to reduce a power-generating cost.

In the related patent of the fuel cell, Taiwan Patent Publication No. 200743240 discloses a fuel cell system having a power management function. The fuel cell system charges a secondary cell thereof through two circuits, “an internal load power supply circuit” and “a charging unit”, rather than directly charging the secondary cell through the charging unit, so that a charging energy of the secondary cell may be lost on the internal load power supply circuit.

To reduce the energy loss, the known circuit structure is required to be adjusted, so as to reduce the power-generating cost of the fuel cell.

### SUMMARY OF THE INVENTION

The invention is directed to a fuel cell system and a power management method thereof, capable of reducing a loss of power due to power conversion while transmitting the power from a fuel cell power-generating part to the internal load.

Additional aspects and advantages of the invention will be set forth in the description of the techniques disclosed in the invention.

To achieve one of or all aforementioned and other advantages, an embodiment of the invention provides a fuel cell system including a fuel cell power-generating part, a state detector, a secondary cell, a charging circuit, a first internal load power supply circuit, a second internal load power supply circuit, a control unit, a path selection circuit, an internal load, and an external load power supply circuit. The fuel cell power-generating part is capable of providing a first electric power. The state detector is coupled to the fuel cell power-generating part, and is capable of detecting the first electric power provided by the fuel cell power-generating part. The secondary cell is capable of providing a second electric power. The charging circuit is coupled between the fuel cell power-generating part and the secondary cell, and is capable of charging the secondary cell. The first internal load power supply circuit is coupled to the fuel cell power-generating part. The second internal load power supply circuit is coupled to the secondary cell. The control unit is coupled to the state detector, the charging circuit, the first internal load power supply circuit, and the second internal load power supply circuit. The path selection circuit is coupled to the first internal load power supply circuit and the second internal load power supply circuit. The internal load is coupled to the path selection circuit. The external load power supply circuit is coupled to the fuel cell power-generating part and the control unit, and is capable of providing power generated by the fuel cell power-generating part to an external load. Therein, when the first electric power detected by the state detector is less than a first rated power of the internal load, the control unit enables the charging circuit, so that the charging circuit transmits power output from the fuel cell power-generating part to the secondary cell, and the secondary cell provides power to the internal load through the second internal load power supply circuit and the path selection circuit. When the first electric power detected by the state detector is greater than or equal to the first rated power and is less than a second rated power of the external load, the control unit disables the external load power supply circuit and enables the first internal load power supply circuit, and the path selection circuit electrically disconnects the second internal load power supply circuit from the internal load, so that the power output from the fuel cell power-generating part is transmitted to the internal load through the first internal load power supply circuit and the path selection circuit. When the first electric power detected by the state detector is greater than or equal to a sum of the first rated power and the second rated power, the control unit enables the first internal load power supply circuit and the external load power supply circuit, and the path selection circuit electrically disconnects the second internal load power supply circuit from the internal load, so that the power output from the fuel cell power-generating part is transmitted to the internal load through the first internal load power supply circuit and the path selection circuit, and the power output from the fuel cell power-generating part is transmitted to the external load through the external load power supply circuit.

An embodiment of the invention provides a power management method of a fuel cell system, wherein the fuel cell system includes a fuel cell power-generating part, a state detector, a secondary cell, a charging circuit, a first internal load power supply circuit, a second internal load power supply circuit, a control unit, a path selection circuit, an internal load, and an external load power supply circuit. The fuel cell power-generating part is capable of providing a first electric power. The state detector is capable of detecting the first electric power provided by the fuel cell power-generating part. The secondary cell is capable of providing a second electric power. The charging circuit is capable of charging the secondary cell. The external load power supply circuit is capable of providing power provided by the fuel cell power-generating part to an external load. The power management method may be described as follows. The state detector detects the first electric power provided by the fuel cell power-generating part. When the first electric power detected by the state detector is less than a first rated power of the internal load, the control unit enables the charging circuit, so that the charging circuit transmits power output from the fuel cell power-generating part to the secondary cell, and the secondary cell provides power to the internal load through the second internal load power supply circuit and the path selection circuit. When the first electric power detected by the state detector is greater than or equal to the first rated power and is less than a second rated power of the external load, the control unit disables the external load power supply circuit and enables the first internal load power supply circuit, and the path selection circuit electrically disconnects the second internal load power supply circuit from the internal load, so that the power output from the fuel cell power-generating part is transmitted to the internal load through the first internal load power supply circuit and the path selection circuit. When the first electric power detected by the state detector is greater than or equal to a sum of the first rated power and the second rated power, the control unit enables the first internal load power supply circuit and the external load power supply circuit, and the path selection circuit electrically disconnects the second internal load power supply circuit from the internal load, so that the power output from the fuel cell power-generating part is transmitted to the internal load through the first internal load power supply circuit and the path selection circuit, and the power output from the fuel cell power-generating part is transmitted to the external load through the external load power supply circuit.

In an embodiment of the invention, when the first electric power detected by the state detector is greater than the first rated power, the control unit enables the charging circuit, so that the charging circuit charges the secondary cell through the power output from the fuel cell power-generating part.

In an embodiment of the invention, the path selection circuit includes a diode, a transistor, and a controller. The diode is coupled to the first internal load power supply circuit. The transistor is coupled to the second internal load power supply circuit, and is capable of switching an output of the second internal load power supply circuit. The controller is coupled to the first internal load power supply circuit, the second internal load power supply circuit, and the transistor, and is capable of controlling the transistor to switch on/off by comparing a first specific voltage output from the first internal load power supply circuit and a second specific voltage output from the second internal load power supply circuit.

According to the above descriptions, the embodiment of the invention has at least one of the following advantages. The fuel cell system of the embodiment of the invention has two internal load power supply circuits and a path selection circuit, so that different power supply sources may use different internal load power supply circuits, so as to reduce the power loss caused by excessive power conversion stages and a power-generating cost of the fuel cell.

In order to make the aforementioned and other features and advantages of the invention comprehensible, several exemplary embodiments accompanied with figures are described in detail below.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a fuel cell system according to an embodiment of the invention.

FIG. 2 is a circuit diagram of a path selection circuit according to an embodiment of the invention.

FIG. 3 is a flowchart illustrating a power management method of a fuel cell system according to an embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

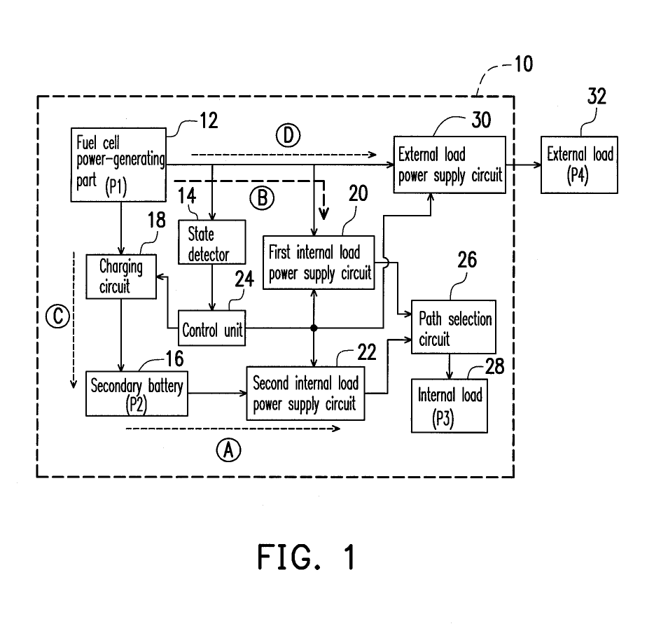

FIG. 1 is a schematic diagram illustrating a fuel cell system according to an embodiment of the invention. Referring to FIG. 1, the fuel cell system 10 includes a fuel cell power-generating part 12, a state detector 14, a secondary cell 16, a charging circuit 18, a first internal load power supply circuit 20, a second internal load power supply circuit 22, a control unit 24, a path selection circuit 26, an internal load 28, and an external load power supply circuit 30.

The fuel cell power-generating part 12 is capable of providing a first electric power P1. The state detector 14 is coupled to the fuel cell power-generating part 12, and is capable of detecting the first electric power P1 provided by the fuel cell power-generating part 12. The secondary cell 16 is capable of providing a second electric power P2 to serve as a power supply for activating the fuel cell system 10. The charging circuit 18 is coupled between the fuel cell power-generating part 12 and the secondary cell 16, and is capable of charging the secondary cell 16. The first internal load power supply circuit 20 is coupled to the fuel cell power-generating part 12, the second internal load power supply circuit 22 is coupled to the secondary cell 16, and the control unit 24 is coupled to the state detector 14, the charging circuit 18, the first internal load power supply circuit 20, and the second internal load power supply circuit 22. The path selection circuit 26 is coupled to the first internal load power supply circuit 20, the second internal load power supply circuit 22, and the internal load 28. The external load power supply circuit 30 is coupled to the fuel cell power-generating part 12 and the control unit 24, and is capable of providing the power generated by the fuel cell power-generating part 12 to an external load 32.

In the embodiment, the first internal load power supply circuit 20 and the second internal load power supply load 22 are respectively a direct current (DC)-DC converter, which is used for converting a voltage value of a DC voltage into another voltage value. Moreover, the internal load 28 roughly refers to the other power-consuming devices other than the symbolized devices in the fuel cell system 10 of FIG. 1, such as, a microprocessor, a bump or a fan, etc., though the invention is not limited thereto.

When the fuel cell power-generating part 12 starts to generate power, it requires an activation period for the first electric power P1 output from the fuel cell power-generating part 12 reaching a rated power of the external load 32. During the activation period of the fuel cell power-generating part 12, the internal power supply loops of the whole fuel cell system 10 are classified into four situations. The first situation is that the fuel cell power-generating part 12 does not provide enough power to the internal load 28, namely, the first electric power P1 is less than a first rated power P3 of the internal load 28. At the same time, the secondary cell 16 transmits the power required by the internal load 28 through the second internal load power supply circuit 22, and the power generated by the fuel cell generating-part 12 is transmitted to the secondary cell 16 through the charging circuit 18. In this case, the power supply loop is a path shown by a dot line A and a dot line C of FIG. 1. The second situation is that the first electric power P1 output from the fuel cell power-generating part 12 is equal to the first rated power P3 of the internal load 28. The control unit 24 enables the first internal load power supply circuit 20, and the path selection circuit 26 allows the fuel cell power-generating part 12 to provide power to the internal load 28 through the first internal load power supply circuit 20, and electrically disconnects the second internal load power supply circuit 22 from the internal load 28. In this case, the power supply loop is changed from the dot lines A and C to a dot line B. The third situation is that the fuel cell power-generating part 12 generates enough power for providing to the internal load 28 and the secondary cell 16 except the external load 32, namely, the first electric power P1 is greater than the first rated power P3 of the internal load 28 and is less than a second rated power P4 of the external load 32. The control unit 24 enables the first internal load power supply circuit 20 and the charging circuit 18, so that the fuel cell power-generating part 12 provides power to the internal load 28 and the secondary cell 16. In this case, the power supply loop is shown as the dot lines B and C. The fourth situation is that the fuel cell power-generating part 12 may generate enough power for providing to the external load 32, the internal load 28, and the secondary cell 16, namely, the first electric power P1 is greater than or equal to a sum (P3+P4) of the first rated power P3 and the second rated power P4. The control unit 24 enables the first internal load power supply circuit 20, the charging circuit 18, and the external load power supply circuit 30, so that the fuel cell power-generating part 12 provides power to the internal load 28, the secondary cell 16, and the external load 32. In this case, the power supply loop is shown as the dot lines B, C, and D.

According to the above descriptions, it is known that the control unit 24 may selectively enable or disable the charging circuit 18, the first internal load power supply circuit 20, the second internal load power supply circuit 22, and the external load power supply circuit 30 according to a magnitude of the first electric power P1 detected by the state detector 14. In detail, when the first electric power P1 detected by the state detector 14 is less than the first rated power P3 of the internal load 28, the control unit 24 enables the charging circuit 18 and the second internal load power supply circuit 22, so that the charging circuit 18 transmits the power output from the fuel cell power-generating part 12 to the secondary cell 16, and the secondary cell 16 provides power to the internal load 28 through the second internal load power supply circuit 22 and the path selection circuit 26. Moreover, when the first electric power P1 detected by the state detector 14 is greater than or equal to the first rated power P3 of the internal load 28 and is less than the second rated power P4 of the external load 32, the control unit 24 disables the external load power supply circuit 30 and enables the first internal load power supply circuit 20, and the path selection circuit 26 electrically disconnects the second internal load power supply circuit 22 from the internal load 28, so that the power output from the fuel cell power-generating part 12 is transmitted to the internal load 28 through the first internal load power supply circuit 20 and the path selection circuit 26. It should be noticed that when the path selection circuit 26 electrically disconnects the second internal load power supply circuit 22 from the internal load 28, the second internal load power supply circuit 22 may be selectively maintained in an enabling state or disabled by the control unit 24. Moreover, when the first electric power P1 detected by the state detector 14 is greater than or equal to a sum (P3+P4) of the first rated power P3 and the second rated power P4, the path selection circuit 26 electrically disconnects the second internal load power supply circuit 22 from the internal load 28, and the control unit 24 enables the first internal load power supply circuit 20 and the external load power supply circuit 30, so that the power output from the fuel cell power-generating part 12 is transmitted to the internal load 28 through the first internal load power supply circuit 20 and the path selection circuit 26, and the power output from the fuel cell power-generating part 12 is transmitted to the external load 32 through the external load power supply circuit 30. In the embodiment, when the first electric power P1 is greater than or equal to the sum (P3+P4) of the first rated power P3 and the second rated power P4, the control unit 24 further enables the charging circuit 18, so that the charging circuit 18 charges the secondary cell 16.

According to the above power management method of the fuel cell system 10, when the first electric power P1 of the fuel cell power-generating part 12 is greater than or equal to the first rated power P3 of the internal load 28, the power generated by the fuel cell power-generating part 12 is not transmitted to the internal load 28 through the charging circuit 18, the secondary cell 16, and the second internal load power supply circuit 22, but is transmitted to the internal load 28 through the first internal load power supply circuit 20, so as to avoid excessive depletion of the power generated by the fuel cell power-generating part 12 that is caused by extra conversions of the charging circuit 18 and the secondary cell 16, and accordingly reduce a power-generating cost of the fuel cell system 10.

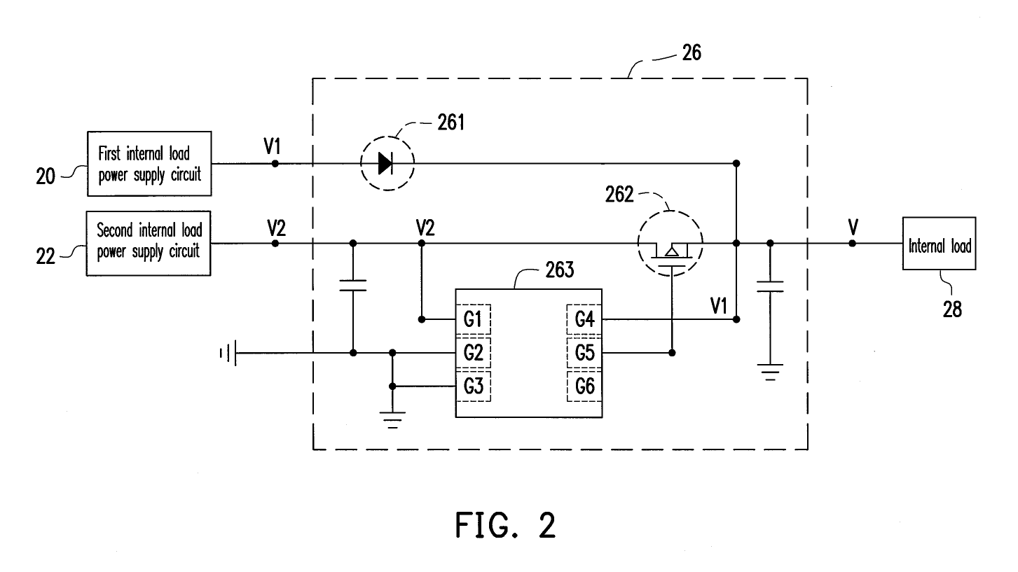

It should be noticed that in the embodiment, the path selection circuit 26 is, for example, a voltage comparator, which is used for comparing a first voltage V1 output from the first internal load power supply circuit 20 and a second voltage V2 output from the second internal load power supply circuit 22. Therein, the path selection circuit 26 may be implemented by an embodiment shown in FIG. 2. FIG. 2 is a circuit diagram of a path selection circuit according to an embodiment of the invention. Referring to FIG. 2, the path selection circuit 26 includes a diode 261, a transistor 262, and a controller 263.

The diode 261 is coupled to the first internal load power supply circuit 20, and is used for switching an output of the first voltage V1 according to a characteristic of the diode 261. Therein, when the first voltage V1 is greater than the second voltage V2, the diode 261 presents a forward bias state and outputs the first voltage V1 to the internal load 28, and an output voltage V output to the internal load 28 is equal to the first voltage V1. When the first voltage V1 is smaller than the second voltage V2, the diode 261 presents a backward bias state, so that the first voltage V1 is not output to the internal load 28.

The transistor 262 is coupled to the second internal load power supply circuit 22, and is capable of switching an output of the second voltage V2. The controller 263 has a plurality of pins G1-G6, wherein the pin G1 is coupled to the second internal load power supply circuit 22, the pins G2 and G3 are coupled to the ground, the pin G4 is coupled to the first internal load power supply circuit 20 through the diode 261, the pin G5 is coupled to the transistor 262, and the pin G6 is in a floating state. The controller 263 receives the second voltage V2 and the first voltage V1 through the pins G1 and G4, and compares the second voltage V2 and the first voltage V1, so as to control the transistor 262 to switch on/off through the pin G5. Therein, a model number of the controller 263 is, for example, LTC4412.

When the first voltage V1 is greater than the second voltage V2, the transistor 262 switches off the output of the second voltage V2, and the first voltage V1 serves as the input of the internal load 28. Therefore, when the first electric power P1 generated by the fuel cell power-generating part 12 is greater than or equal to the first rated power P3 of the internal load 28, since the control unit 24 enables the first internal load power supply circuit 20, the first voltage V1 output from the first internal load power supply circuit 20 is greater than the second voltage V2 output from the second internal load power supply circuit 22, so that the controller 263 switches off the transistor 262, and therefore the output voltage V is equal to the first voltage V1. Moreover, when the control unit 24 disables the first internal load power supply circuit 20, since the second voltage V2 is greater than the first voltage V1, the controller 263 switches on the transistor 262, so that the output voltage V is equal to the second voltage V2. According to the above descriptions, it is known that in the embodiment, magnitudes of the first voltage V1 may be different when the control unit 24 enables or disables the first internal load power supply circuit 20, and the path selection circuit 26 controls the transistor 262 to switch on/off by comparing the first voltage V1 and the second voltage V2, so that the voltage V transmitted to the internal load 28 may be equal to the first voltage V1 or the second voltage V2 according to a variation of the first electric power P1.

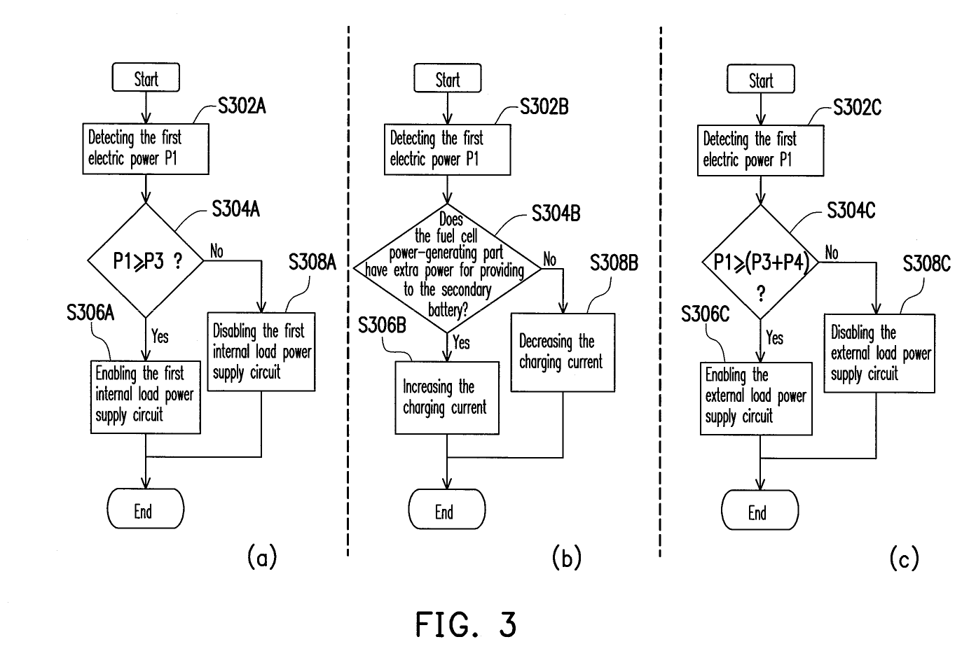

FIG. 3 is a flowchart illustrating a power management method of a fuel cell system according to an embodiment of the invention. Referring to FIG. 3, according to the above descriptions, the power management method of the fuel cell system may be concluded into following three flows (a), (b) and (c).

Firstly, in the flow (a), the state detector 14 detects the first electric power P1 provided by the fuel cell power-generating part 12 (step S302A). Next, the control unit 24 determines whether the first electric power P1 is greater than or equal to the first rated power P3 of the internal load 28 (step S304A). If the first electric power P1 is greater than or equal to the first rated power P3, the control unit 24 enables the first internal load power supply circuit 20 (step S306A); if the first electric power P1 is smaller than the first rated power P3, the enable unit 24 disables the first internal load power supply circuit 20 (step S308A). Therein, when the control unit 24 enables the first internal load power supply circuit 20, the path selection circuit 26 electrically disconnects the second internal load power supply circuit 22 from the internal load 28, and when the control unit 24 disables the first internal load power supply circuit 20, the path selection circuit 26 restores the electrical connection between the second internal load power supply circuit 22 and the internal load 28.

In the flow (b), the state detector 14 detects the first electric power P1 provided by the fuel cell power-generating part 12 (step S302B). Next, the control unit 24 determines whether the fuel cell power-generating part 12 has extra power for providing to the secondary cell 16 (step S304B). Therein, the extra power refers to the power remained after the fuel cell power-generating part 12 supplies power to the internal load 28 and/or the external load 32. If the fuel cell power-generating part 12 has extra power for providing to the secondary cell 16, the control unit 24 controls the charging circuit 18 to increase a charging current of the secondary cell 16 (step S306B), and if the fuel cell power-generating part 12 has no extra power for providing to the secondary cell 16, the control unit 24 controls the charging circuit 18 to decrease the charging current of the secondary cell 16 (step S308B).

In the flow (c), the state detector 14 detects the first electric power P1 provided by the fuel cell power-generating part 12 (step S302C). Next, the control unit 24 determines whether the first electric power P1 is greater than or equal to a sum (P3+P4) of the first rated power P3 and the second rated power P4 (step S304C). If the first electric power P1 is greater than or equal to the sum (P3+P4) of the first rated power P3 and the second rated power P4, the control unit 24 enables the external load power supply circuit 30 (step S306C), and if the first electric power P1 is smaller than the sum (P3+P4) of the first rated power P3 and the second rated power P4, the control unit 24 disables the external load power supply circuit 30 (step S308C).

Moreover, it should be noticed that in the embodiment, the steps in the flows (a), (b) and (c) are sequentially executed every a predetermined time interval, so as to increase a power management quality of the fuel cell system. In addition, an executing sequence of the flows (a), (b) and (c) are not limited. In detail, the executing sequence of the flows (a), (b) and (c) has following six variations.

1. (a)→(b)→(c);

2. (a)→(c)→(b);

3. (b)→(a)→(c);

4. (b)→(c)→(a);

5. (c)→(a)→(b);

6. (c)→(b)→(a).

In summary, the embodiment of the invention has at least one of the following advantages. The fuel cell system of the invention has two internal load power supply circuits and a path selection circuit, so that different power supply sources may use different internal load power supply circuits, so as to reduce the power loss caused by excessive power conversion stages, and a power-generating cost of the fuel cell.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A fuel cell system, comprising:
a fuel cell power-generating part, capable of providing a first electric power;
a state detector, coupled to the fuel cell power-generating part, capable of detecting the first electric power provided by the fuel cell power-generating part;
a secondary cell, capable of providing a second electric power;
a charging circuit, coupled between the fuel cell power-generating part and the secondary cell, capable of charging the secondary cell;
a first internal load power supply circuit, coupled to the fuel cell power-generating part;
a second internal load power supply circuit, coupled to the secondary cell;
a control unit, coupled to the state detector, the charging circuit, the first internal load power supply circuit, and the second internal load power supply circuit;
a path selection circuit, coupled to the first internal load power supply circuit and the second internal load power supply circuit;
an internal load, coupled to the path selection circuit; and
an external load power supply circuit, coupled to the fuel cell power-generating part and the control unit, capable of providing power generated by the fuel cell power-generating part to an external load,
wherein when the first electric power detected by the state detector is less than a first rated power of the internal load, the control unit enables the charging circuit, so that the charging circuit transmits power output from the fuel cell power-generating part to the secondary cell, and the secondary cell provides power to the internal load through the second internal load power supply circuit and the path selection circuit,
when the first electric power detected by the state detector is greater than or equal to the first rated power and is less than a second rated power of the external load, the control unit disables the external load power supply circuit and enables the first internal load power supply circuit, and the path selection circuit electrically disconnects the second internal load power supply circuit from the internal load, so that the power output from the fuel cell power-generating part is transmitted to the internal load through the first internal load power supply circuit and the path selection circuit,
when the first electric power detected by the state detector is greater than or equal to a sum of the first rated power and the second rated power, the control unit enables the first internal load power supply circuit and the external load power supply circuit, and the path selection circuit electrically disconnects the second internal load power supply circuit from the internal load, so that the power output from the fuel cell power-generating part is transmitted to the internal load through the first internal load power supply circuit and the path selection circuit, and the power output from the fuel cell power-generating part is transmitted to the external load through the external load power supply circuit.

2. The fuel cell system as claimed in claim 1, wherein when the first electric power detected by the state detector is greater than the first rated power, the control unit enables the charging circuit, so that the charging circuit charges the secondary cell through the power output from the fuel cell power-generating part.

3. The fuel cell system as claimed in claim 1, wherein the path selection circuit comprises:
a diode, coupled to the first internal load power supply circuit;
a transistor, coupled to the second internal load power supply circuit, capable of switching an output of the second internal load power supply circuit; and
a controller, coupled to the first internal load power supply circuit, the second internal load power supply circuit, and the transistor, capable of controlling the transistor to switch on/off by comparing a first specific voltage output from the first internal load power supply circuit and a second specific voltage output from the second internal load power supply circuit.

4. A power management method of a fuel cell system, the fuel cell system comprising a fuel cell power-generating part, a state detector, a secondary cell, a charging circuit, a first internal load power supply circuit, a second internal load power supply circuit, a control unit, a path selection circuit, an internal load, and an external load power supply circuit, the fuel cell power-generating part capable of providing a first electric power, the state detector being capable of detecting the first electric power provided by the fuel cell power-generating part, the secondary cell capable of providing a second electric power, the charging circuit capable of charging the secondary cell, the external load power supply circuit capable of providing power provided by the fuel cell power-generating part to an external load, and the power management method of the fuel cell system comprising:
detecting the first electric power provided by the fuel cell power-generating part by the state detector;
when the first electric power detected by the state detector is less than a first rated power of the internal load, enabling the charging circuit by the control unit, so that the charging circuit transmits power output from the fuel cell power-generating part to the secondary cell, and the secondary cell provides power to the internal load through the second internal load power supply circuit and the path selection circuit;
when the first electric power detected by the state detector is greater than or equal to the first rated power and is less than a second rated power of the external load, disabling the external load power supply circuit and enabling the first internal load power supply circuit by the control unit, and electrically disconnecting the second internal load power supply circuit from the internal load by the path selection circuit, so that the power output from the fuel cell power-generating part is transmitted to the internal load through the first internal load power supply circuit and the path selection circuit; and
when the first electric power detected by the state detector is greater than or equal to a sum of the first rated power and the second rated power, enabling the first internal load power supply circuit and the external load power supply circuit by the control unit, and electrically disconnecting the second internal load power supply circuit from the internal load by the path selection circuit, so that the power output from the fuel cell power-generating part is transmitted to the internal load through the first internal load power supply circuit and the path selection circuit, and the power output from the fuel cell power-generating part is transmitted to the external load through the external load power supply circuit.

5. The power management method of the fuel cell system as claimed in claim 4, wherein when the first electric power detected by the state detector is greater than the first rated power, the control unit enables the charging circuit, so that the charging circuit charges the secondary cell through the power output from the fuel cell power-generating part.

6. The power management method of the fuel cell system as claimed in claim 4, wherein the charging circuit is coupled between the fuel cell power-generating part and the secondary cell, the control unit is coupled to the state detector, the charging circuit, the first internal load power supply circuit, the second internal load power supply circuit, and the external load power supply circuit, the second internal load power supply circuit is coupled to the secondary cell, the first internal load power supply circuit and the external load power supply circuit are coupled to the fuel cell power-generating part, the path selection circuit is coupled to the first internal load power supply circuit and the second internal load power supply circuit, and the internal load is coupled to the path selection circuit.

7. The power management method of the fuel cell system as claimed in claim 4, wherein the path selection circuit comprises:
a diode, coupled to the first internal load power supply circuit;
a transistor, coupled to the second internal load power supply circuit, capable of switching an output of the second internal load power supply circuit; and
a controller, coupled to the first internal load power supply circuit, the second internal load power supply circuit, and the transistor, capable of controlling the transistor to switch on/off by comparing a first specific voltage output from the first internal load power supply circuit and a second specific voltage output from the second internal load power supply circuit.
